(19) United States
(12) Patent Application Publication
(10) Pub. No.: US 2026/0336078 A1
(43) Pub. Date: Oct. 29, 2026

(54) TURNBUCKLE AND WIRE TENSIONING DEVICE

(71) Applicant: NAGAKI SEIKI CO., LTD., Osaka (JP)

(72) Inventors: Antoine Leo ANDRIEU, Osaka (JP); Kosuke OKAMOTO, Osaka (JP)

(21) Appl. No.: 19/104,881

(22) PCT Filed: Jun. 20, 2023
(86) PCT No.: PCT/JP2023/022721

§ 371 Date: Feb. 19, 2025

(30) Foreign Application Priority Data
Sep. 1, 2022 (JP) 2022-139412

(51) Int. Cl. B25B 25/00

(52) U.S. Cl. CPC B25B 25/00

(57) ABSTRACT

A turnbuckle to be used to apply tension to a wire rod is provided. This turnbuckle comprises an outer cylindrical unit, an inner cylindrical unit, an operation unit, a driving portion, and a position detection portion. The inner cylindrical unit is inserted into the outer cylindrical unit from one end section of the axial direction. The operation unit comprises: a threaded shaft that is inserted through the outer and inner cylindrical units; and a nut that is threadably mounted on the threaded shaft. The driving portion is configured so as to move the nut along the threaded shaft by causing the threaded shaft to rotate around the shaft axis thereof. The position detection portion comprises at least one sensor that is disposed on the outer peripheral side of the outer cylindrical unit and detects the position of the nut.

### CROSS REFERENCE TO RELATED APPLICATIONS

This application is a 371 U.S. National Phase of International Application No. PCT/JP2023/022721, filed on Jun. 20, 2023, which claims priority to Japanese Patent Application No. 2022-139412, filed Sep. 1, 2022. The entire disclosures of the above applications are incorporated herein by reference.

### BACKGROUND

### Technical Field

The present disclosure relates to an expander and a wire tensioning device.

### Related Art

When performing wire tensioning work in electrical construction, railway maintenance, and or fruit tree trellis creation, it is common to use a wire gripper that grips wire-like bodies such as wires and electric wires, and an expander to perform the work. JP 2018-11495A discloses an expander that performs extending and shortening operation by manually rotating a bolt.

A great force is required to rotate a bolt, and the degree of pulling of a wire-like body must be visually confirmed in the pulling operation of the wire-like body, which requires a high degree of skill. In view of the above circumstances, the present disclosure provides an expander and a wire tensioning device that can easily and accurately perform wire tensioning work.

### SUMMARY

According to an aspect of the present disclosure, an expander adapted to be used to pull wire. The expander includes an outer cylinder portion, an inner cylinder portion, a moving portion, a driving portion, and a position detection portion. The inner cylinder portion is inserted into the outer cylinder portion from one end in an axial direction. The moving portion includes a screw shaft inserted through the outer cylinder portion and the inner cylinder portion, and a nut fixed to another end of the inner cylinder portion in the axial direction and screwed with the screw shaft. The driving portion is configured to move the nut along the screw shaft by rotating the screw shaft about its axis. The position detection portion is provided on an outer circumferential side of the outer cylinder portion and includes at least a sensor that detects a position of the nut.

According to such an aspect, the expander can be operated easily, so that the wire tensioning work can be performed quickly and safely.

### BRIEF DESCRIPTION OF THE DRAWINGS

FIG. 1 is a front view showing a first embodiment of a wire tensioning device of the present disclosure.

FIG. 2 is a perspective view showing a configuration of a support on the left side in FIG. 1.

FIG. 3 is a perspective view showing a configuration of a support on the right side in FIG. 1.

FIG. 4 is a vertical cross-sectional view showing a configuration near a moving portion and a driving portion in an expander of the first embodiment.

FIG. 5 is a perspective view (internal transparent view) illustrating a schematic configuration of a moving portion in an expander of the first embodiment.

FIG. 6 is a block diagram showing a configuration of a control board in an expander of the first embodiment.

FIG. 7 is a front view showing a configuration of a body cylinder portion side of an expander of a second embodiment.

FIG. 8 is a front view showing a configuration near a driving portion in an expander of a third embodiment.

FIG. 9 is a vertical cross-sectional view near a driving portion shown in FIG. 8.

FIG. 10 is a perspective view showing a configuration of a fixing member in an expander of a fourth embodiment.

### DETAILED DESCRIPTION

Hereinafter, an embodiment of the present disclosure will be described with reference to drawings. Various features described in the embodiment below can be combined with each other.

A program for realizing a software in the present embodiment may be provided as a non-transitory computer readable storage medium that can be read by a computer, may be provided for download from an external server, or may be provided in such a manner that the program can be activated on an external computer to realize function thereof on a client terminal (so-called cloud computing).

A term “unit” in the present embodiment may include, for example, a combination of a hardware resource implemented as circuits in a broad sense and information processing of software that can be concretely realized by the hardware resource. Furthermore, various kinds of information are described in the present embodiment, and such information may be represented by, for example, physical values of signal values representing voltage and current, high and low signal values as a set of binary bits consisting of 0 or 1, or quantum superposition (so-called qubits), and communication and computation may be executed on a circuit in a broad sense.

The circuit in a broad sense is a circuit realized by at least properly combining a circuit, circuitry, a processor, a memory, and the like. In other words, a circuit includes an application specific integrated circuit (ASIC), a programmable logic device (e.g., simple programmable logic device (SPLD), a complex programmable logic device (CLPD), field programmable gate array (FPGA), and the like.

### Wire Tensioning Device

First, a wire tensioning device of the present disclosure will be described.

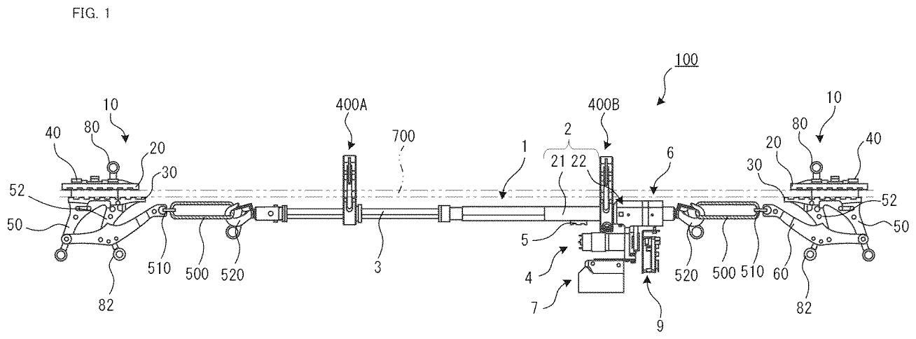

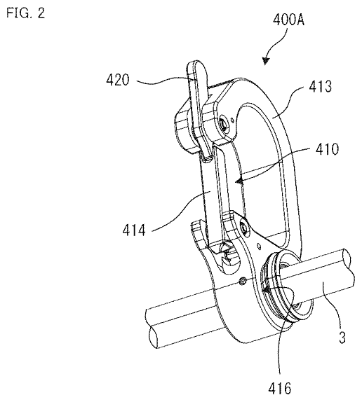

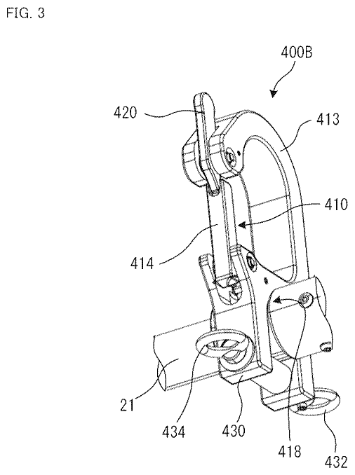

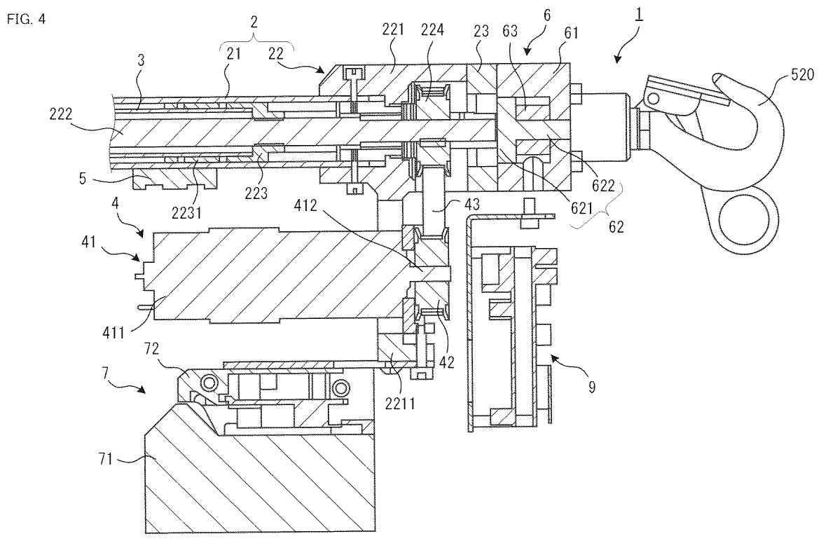

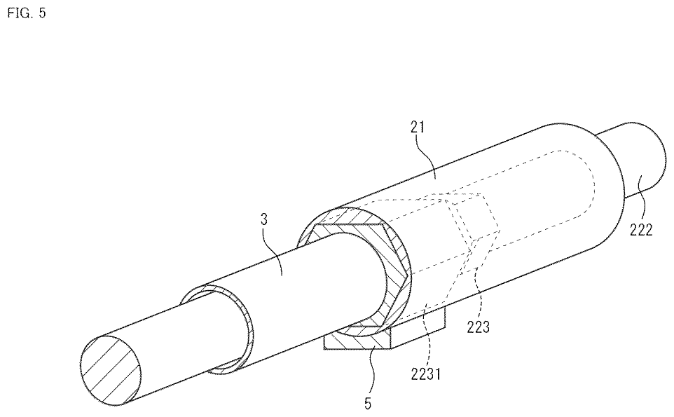

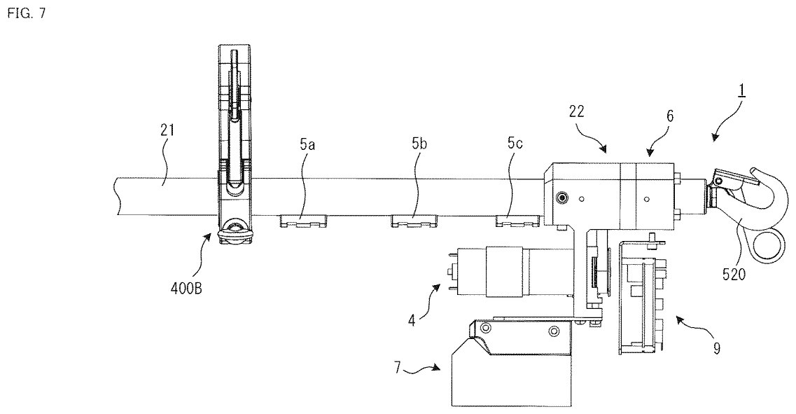

FIG. 1 is a front view showing a first embodiment of a wire tensioning device of the present disclosure. FIG. 2 and FIG. 3 are perspective views showing a configuration of a support in FIG. 1, respectively. In the following description, an upper side is referred to as “up” or “upward” and a lower side is referred to as “down” or “downward” in FIG. 1 to FIG. 3 (the same applies to FIG. 4, FIG. 5, and FIG. 7 to FIG. 10). In addition, a right side is referred to as “right” or “right side” and a left side is referred to as “left” or “left side” in FIG. 1 to FIG. 3 (the same applies to FIG. 4, FIG. 5, and FIG. 7 to FIG. 10). The wire tensioning device (also referred to as “strain rod”) 100 shown in FIG. 1 is used, for example, to cut a coated electric wire 700 in an aerial state. In FIG. 1, the coated electric wire 700 is indicated by two-dot chain lines.

This wire tensioning device 100 includes a pair of wire grippers 10 for gripping the coated electric wire 700 (overhead wire) and a long expander 1 whose both ends are coupled to these wire grippers 10 via coupling tools 500, 510.

The expander 1 is configured such that the longitudinal dimension thereof can be expanded or contracted by driving a driving portion 4 provided on the right side (another side) of the expander 1 in the longitudinal direction.

### Wire Gripper

A first link piece 50 and a second link piece 52 are pivotally supported on the lower side of a base portion 40 of the wire gripper 10 in a swingable manner. The swing end of the first link piece 50 and the swing end of the second link piece 52 are both coupled to an operation arm 60 to form a parallel link mechanism. As shown in FIG. 1, the coated electric wire 700 is gripped from an up-down direction by an upper wire gripping body 20 and a lower wire gripping body 30. The upper wire gripping body 20 is fixed to the base portion 40. On the other hand, the lower wire gripping body 30 is coupled above the first link piece 50 and the second link piece 52 so that the lower wire gripping body 30 can be brought close to and be separated from the upper wire gripping body 20.

With such a configuration, when the operation arm 60 is pulled toward the expander 1, the first link piece 50 and the second link piece 52 swing. As a result, the lower wire gripping body 30 is displaced upward, i.e., the lower wire gripping body 30 is brought close to the upper wire gripping body 20 and can grip the coated electric wire 700.

The base portion 40 is provided with a support ring 80 that protrudes upward. The support ring 80 is an annular body that constitutes a lifting tool locking body. The support ring 80 can be suspended by a remote control tool to lift the wire gripper 10. The lower wire gripping body 30 is provided with a tightening portion 82 that protrudes downward. The upper wire gripping body 20 and the lower wire gripping body 30 can tighten the coated electric wire 700 by rotating the tightening portion 82.

### Support

The wire tensioning device 100 includes a pair of supports 400A and 400B attached to the expander 1.

As shown in FIG. 2 and FIG. 3, the supports 400A and 400B each include a substantially C-shaped support body 413 having an opening 410 on one side and a closing piece 414 which closes the opening 410 of the support body 413. With such a configuration, after introducing the coated electric wire 700 into the inside of the support body 413 through the opening 410, the opening 410 of the support body 413 is closed by the closing piece 414, so that the expander 1 can be supported on the coated electric wire 700.

In addition, an engagement piece 420 that engages with the closing piece 414 is rotatably provided in a state in which the opening 410 is closed by the closing piece 414 at the end of the support body 413 facing the opening 410.

As shown in FIG. 2, a through hole 416 through which the expander 1 (moving shaft portion 3) is inserted is formed in the lower part of the support body 413 in the support 400A.

On the other hand, as shown in FIG. 3, a through hole 418 through which the expander 1 (body cylinder portion 2) is inserted is formed in the lower part of the support body 413 in the support 400B.

In addition, the support 400B is provided with a fixing portion 430 in the lower part of the support body 413 for fixing the expander 1 at a desired position in the longitudinal direction and at a predetermined rotation angle around an axis. Furthermore, operation portions 432 and 434 are provided on both sides for operating the fixing portion 430 with a remote control tool.

With this support 400B, an operation for changing the direction of the end of the coated electric wire 700 on the right side after cutting (sorting operation) can be performed so that the ends of the coated electric wire 700 after cutting do not come into contact with each other.

### Expander

The above wire gripper 10 is coupled to both ends of the expander 1. The expander 1 is a device adapted to be used to pull the coated electric wire (wire) 700.

### First Embodiment

First, the first embodiment of the expander will be described.

FIG. 4 is a vertical cross-sectional view showing a configuration near a moving portion and a driving portion in the expander of the first embodiment. FIG. 5 is a perspective view (internal transparent view) illustrating a schematic configuration of the moving portion in the expander of the first embodiment.

As shown in FIG. 1 and FIG. 4, the expander 1 includes a body cylinder portion 2 having a cylindrical shape and a small-diameter cylindrical moving shaft portion (inner cylinder portion) 3 provided so as to be relatively movable in the longitudinal direction of the body cylinder portion 2.

The body cylinder portion 2 includes a cylindrical portion (outer cylinder portion) 21 made of, for example, aluminum or FRP (fiber-reinforced plastic), and a moving portion 22 fixed to the right end (another end) of the cylindrical portion 21 in the axial direction.

The moving shaft portion 3 is inserted into the cylindrical portion 21 from the left end (one end) in the axial direction. The moving shaft portion 3 is formed of, for example, FRP.

The moving portion 22 includes a casing 221 made of, for example, aluminum alloy, a screw shaft 222 inserted through the cylindrical portion 21 and the moving shaft portion 3, a nut 223 screwed with the screw shaft 222, and a pulley 224 attached to the right end (another end) of the screw shaft 222 in the axial direction.

The right end of the screw shaft 222 in the axial direction protrudes from the cylindrical portion 21 into the casing 221. The pulley 224 is fixed to a portion of the screw shaft 222 that protrudes from the cylindrical portion 21. Thus, the pulley 224 is housed in the casing 221.

As shown in FIG. 5, the nut 223 has a hexagonal outer shape and is formed with a connecting portion 2231 that protrudes to the left side thereof in the axial direction and has a hexagonal outer shape. The right end (another end) of the moving shaft portion 3 in the axial direction is inserted into and fixed to the inside of the connecting portion 2231. The nut 223 is preferably made of an iron-base metal material.

The inner peripheral surface of the cylindrical portion 21 has a hexagonal shape corresponding to the outer shape of the connecting portion 2231. Thus, the nut 223 is prevented from rotating about the axial direction relative to the cylindrical portion 21.

The casing 221 includes a support portion 2211 that protrudes downward.

In the middle of the support portion 2211 in the longitudinal direction (up-down direction), the driving portion 4 is provided.

The driving portion 4 includes a motor 41, and a motor body 411 of the motor 41 is fixed to the support portion 2211. Furthermore, the driving portion 4 includes a pulley 42 attached to a rotary shaft 412 of the motor 41 and a timing belt 43 wound around the pulley 42 and the pulley 224.

Thus, in the present embodiment, a power transmission mechanism coupled to the screw shaft 222 comprises the pulley 42, the pulley 224 and the timing belt 43.

The motor 41 (driving portion 4) is configured to rotate the screw shaft 222 about its axis via the power transmission mechanism. By rotating the screw shaft 222 about its axis, the nut 223 can move back and forth along the screw shaft 222 while being guided by the inner peripheral surface of the cylindrical portion 21. As a result, the moving shaft portion 3, which is connected to the nut 223, is configured to be able to freely comes in and out from the cylindrical portion 21.

A sensor (a position detection portion) 5 configured to detect the position of the nut 223 is provided on the outer circumferential side of the cylindrical portion 21. The expansion/contraction operation of the expander 1 can be performed accurately by detecting the position of the nut 223 with the sensor 5.

The sensor 5 may be a magnetic sensor, an optical sensor, a contact sensor (limit sensor), etc. In the case where the nut 223 is made of a metal material, the sensor 5 is preferably a magnetic sensor. In this case, it is easier to detect the position of the nut 223 more accurately.

In addition, a tension detection portion 6 configured so as to detect the tension applied to the coated electric wire (wire) 700 is provided at the right end (another end) of the moving portion 22 (the cylindrical portion 21) in the axial direction.

In the present embodiment, the tension detection portion 6 is fixed to the casing 221 of the moving portion 22 (the right end of the body cylinder portion 2) via a spacer 23.

The tension detection portion 6 includes a casing 61, a stress applying member 62 having a T-shaped cross section, and a load cell (pressure sensor) 63 located between the casing 61 and the stress applying member 62.

The stress applying member 62 includes a disk-shaped portion 621 and a rod-like portion 622 protruding from the disk-shaped portion 621 to the right side in the axial direction. The rod-like portion 622 is provided so as to penetrate the casing 61, and a fixing member 520 is fixed (connected) to the right end thereof in the axial direction. As shown in FIG. 1, a coupling tool 500 can be locked with the fixing member 520, and the wire gripper 10 is configured to be coupled to the fixing member 520 via the coupling tool 500.

The load cell 63 is arranged between the disk-shaped portion 621 and the casing 61 in contact therewith. When the fixing member 520 is pulled, the stress applying member 62 fixed thereto is also pulled, and the load cell 63 is compressed by the disk-shaped portion 621 (i.e., stress is applied to the load cell 63). This makes it possible to detect the tension applied to the coated electric wire 700.

By providing the tension detection portion 6, it is possible to prevent the application of more tension than necessary to the coated electric wire 700. This allows the wire tensioning work to be safely performed. In particular, the above-mentioned effects can be further improved by the combination with the sensor 5.

From a similar viewpoint, a sensor capable of measuring a current value flowing through the motor 41 may be provided. In this case, the torque when the motor 41 is driven can be grasped by measuring the current value. Specifically, as the current value increases, the torque generated when the motor 41 is driven increases. Thus, by measuring the current value flowing through the motor 41, it is possible to prevent the application of more tension than necessary to the coated electric wire 700.

In addition, when the expander 1 is extended and the nut 223 comes into contact with the left end (one end) of the cylindrical portion 21, or when the expander 1 contracts and the nut 223 comes into contact with the moving portion 22 (casing 221), the rotation of a motor 1700 stops and the current value flowing to the motor 41 increases. Thus, by measuring the current value flowing to the motor 41, the position of the nut 223 can also be detected.

The left end (one end) of the moving shaft portion 3 is also provided with the fixing member 520 capable of locking a coupling tool 500. The fixing member 520 is also configured to be coupled to the wire gripper 10 via the coupling tool 500 in the same manner as described above.

A power supply part 7 is provided at the lower end of the support portion 2211 (the end opposite to the moving portion 22 via the driving portion 4). The power supply part 7 includes a battery 71 and a battery mounting portion 72 into which the battery 71 is detachably mounted. The battery mounting portion 72 is fixed to the support portion 2211. The power supply part 7 supplies power to at least the sensor (position detection portion) 5. In the present embodiment, the power supply part 7 can supply power to the sensor (position detection portion) 5, the motor 41, a load cell 63, and the like.

The battery 71 may be, for example, a primary battery such as a dry cell or solar cell, or a secondary battery such as a lithium ion battery.

A control board 9 is mounted on a support member (not shown) below the tension detection portion 6. A cover (not shown) preferably covering the control board 9 is provided.

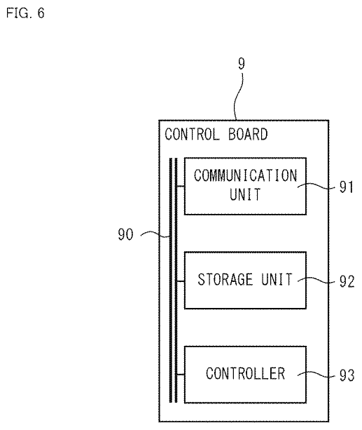

FIG. 6 is a block diagram showing a configuration of the control board in the expander of the first embodiment.

The control board 9 controls at least the sensor (position detection portion) 5. The control board 9 shown in FIG. 6 is, for example, a dedicated control device for the sensor (position detection portion) 5, the motor 41, the load cell 63, and the like, which are electrically connected thereto. The control board 9 includes a communication unit 91, a storage unit 92, and a controller 93, which are electrically connected via a communication bus 90.

The communication unit 91 is configured to transmit various electrical signals from the control board 9 to an external component. Furthermore, the communication unit 91 is configured to receive various electrical signals from an external component to the control board 9. More preferably, the communication unit 91 has a network communication function, thereby various information can be communicated with an external apparatus via a network such as the Internet.

The communication unit 91 may be preferably wired communication means such as USB, IEEE1394, Thunderbolt (registered trademark), wired LAN network communication, and the like, but may include wireless LAN network communication, mobile communication such as 3G/LTE/5G, Bluetooth (registered trademark) communication, and the like as needed. In other words, more preferably, the communication unit 91 is implemented as a set of these communication means.

The storage unit 92 is configured to store various information as defined by the above description.

This may be implemented as a storage device such as a solid state drive (SSD) storing various programs related to the expander 1 that are executed by the controller 93, or as a memory such as a random access memory (RAM) that stores temporarily necessary information (argument, sequence, etc.) for program operation.

The storage unit 92 stores various programs, variables, etc. related to the expander 1 that are executed by the controller 93. Particularly preferably, information on the construction plan to be performed using the expander 1 is stored.

The controller 93 processes and controls overall operation pertaining to the expander 1.

The controller 93 is, for example, an unshown central processing unit (CPU). The controller 93 realizes various functions pertaining to the expander 1 by reading a predetermined program stored in the storage unit 92. In other words, the controller 93 as an example of hardware is configured to concretely realize information processing of software stored in the storage unit 92.

The controller 93 is not limited to being a single controller but may be implemented with a plurality of controllers 93 for each function. Moreover, a combination thereof may be applied.

Next, the use of the wire tensioning device 100 will be described.

[1] First, the supports 400A and 400B are attached to the coated electric wire 700 using a remote control device.

[2] Next, a pair of wire grippers 10 coupled to both ends of the expander 1 is mounted to the coated electric wire 700 using a remote control tool. Specifically, the remote control device is hooked onto the support ring 80 to suspend the wire gripper 10. Then, the coated electric wire 700 is inserted between the upper wire gripping body 20 and the lower wire gripping body 30, and the upper wire gripping body 20 is hooked onto the coated electric wire 700.

[3] Next, the coated electric wire 700 is tightened by the upper wire gripping body 20 and the lower wire gripping body 30 by rotating the tightening portion 82.

[4] Then, an external terminal (not shown) is used to actuate the motor 41 to rotate the rotary shaft 412 in a predetermined direction. This also allows the pulley 42 fixed to the rotary shaft 412 and the pulley 224 to rotate via the timing belt 43 wound around the pulley 42. Consequently, the screw shaft 222 connected to the pulley 224 rotates, and the nut 223 screwed with the screw shaft 222 moves in the light direction along the longitudinal direction of the screw shaft 222.

At this time, the moving shaft portion 3 fixed to the nut 223 also moves in the right direction and is pulled into the cylindrical portion 21. That is, the expander 1 contracts. This allows the pair of wire grippers 10 gripping the coated electric wire 700 to be brought close to each other.

As a result, the coated electric wire 700 is in a taut state on the outer side of the wire gripper 10, and in the portion of the coated electric wire 700 between the two wire grippers 10, the coated electric wire 700 is loosened. Then, the loosened portion of the coated electric wire 700 is cut by a cutting tool for indirect live wire.

At this time, the actuation of the motor 41 is stopped by operating an external terminal. This allows the expander 1 to be maintained in a contracted state.

[5] After completing the work, the external terminal is operated to actuate the motor 41 and rotate the rotary shaft 412 in the opposite direction to the above. As a result, the longitudinal dimension of the expander 1 is extended, and the wire grippers 10 are separated from each other.

Thereafter, the tightening portion 82 is rotated using the remote control tool to loosen the tightening of the coated electric wire 700 by the upper wire gripping body 20 and the lower wire gripping body 30, thereby releasing the gripping of the coated electric wire 700.

Next, the pair of wire grippers 10 connected to both ends of the expander 1 is removed from the coated electric wire 700 using a remote control tool. Furthermore, the supports 400A, 400B are removed from the coated electric wire 700 by using a remote control tool.

In this manner, the wire tensioning device 100 can be retrieved.

### Second Embodiment

Next, the second embodiment of the expander 1 will be described.

Hereinafter, although the expander 1 of the second embodiment will be described, a description will be mainly given of differences from the expander 1 of the first embodiment, and the description of similar matters will be omitted.

FIG. 7 is a front view showing a configuration of the body cylinder portion side of the expander of the second embodiment. The expander 1 shown in FIG. 7 has three sensors 5a, 5b, and 5c (position detection portions) arranged at predetermined intervals along the longitudinal direction of the cylindrical portion 21.

By detecting the position of the nut 223 with the left sensor 5a, it is possible to prevent the moving shaft portion 3 from protruding more than necessary from the cylindrical portion 21 (body cylinder portion 2) and falling off.

By detecting the position of the nut 223 with the central sensor 5b, it is possible to define (set) the initial position of the moving shaft portion 3 relative to the cylindrical portion 21 (body cylinder portion 2).

By detecting the position of the nut 223 with the right sensor 5c, it is possible to prevent the moving shaft portion 3 from retracting more than necessary relative to the cylindrical portion 21 (body cylinder portion 2). As a result, damage or the like to the pulley 224 can be prevented.

Note that, any two of the three sensors 5a, 5b, and 5c may be provided, and one or more additional sensors may be provided.

### Third Embodiment

Next, the third embodiment of the expander 1 will be described.

Hereinafter, although the expander 1 of the third embodiment will be described, a description will be mainly given of differences from the expander 1 of the first and the second embodiments, and the description of similar matters will be omitted.

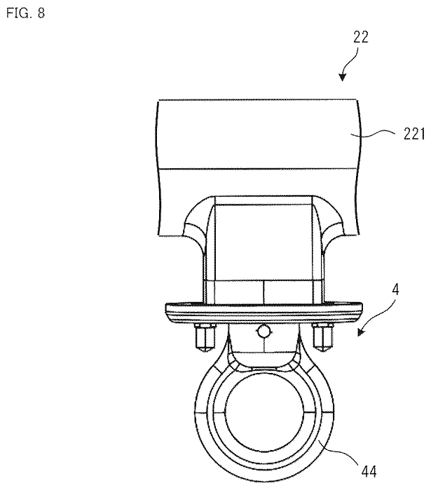

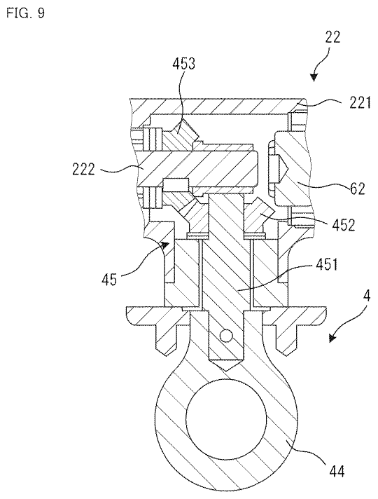

FIG. 8 is a front view showing a configuration near the driving portion in the expander of the third embodiment. FIG. 9 is a vertical cross-sectional view near the driving portion shown in FIG. 8.

The driving portion 4 shown in FIG. 8 and FIG. 9 is configured to be operated manually.

The driving portion 4 includes an operation portion 44 that protrudes from the bottom surface of the casing 221 and is rotated, and a power transmission mechanism 45 coupled to the operation portion 44 and housed in the casing 221.

The power transmission mechanism 45 includes a shaft portion 451 fixed to the operation portion 44, a bevel gear 452 mounted to the upper end of the shaft portion 451 (the end opposite to the operation portion 44), and a bevel gear 453 mounted on the right end (another end) of the screw shaft 222 and meshed with the bevel gear 452.

The rotational operation of the operation portion 44 is converted into the rotational action of the screw shaft 222 via the power transmission mechanism 45.

When the expander 1 is expanded and retracted, a remote control tool (an indirect tool) is engaged with the operation portion 44, and the operation portion 44 is rotated by the remote control tool. This allows the screw shaft 222 in the cylindrical portion 21 to be driven to rotate via the power transmission mechanism 45, and the moving shaft portion 3 in which the nut 223 placed at the end thereof is screwed with the screw shaft 222 moves along the axial direction. As a result, the expander 1 is configured to expand or contract by causing the moving shaft portion 3 to come in and out from the body cylinder portion 2.

With the expander 1 having such a configuration, no power is required to drive the motor, and thus the small power supply part 7 and the control board 9 required to operate the sensors 5, 5a, 5b, and 5c can be placed, for example, on the upper side of the casing 221.

### Fourth Embodiment

Next, the fourth embodiment of the expander 1 will be described.

Hereinafter, although the expander 1 of the fourth embodiment will be described, a description will be mainly given of differences from the expander 1 of the first to third embodiments, and the description of similar matters will be omitted.

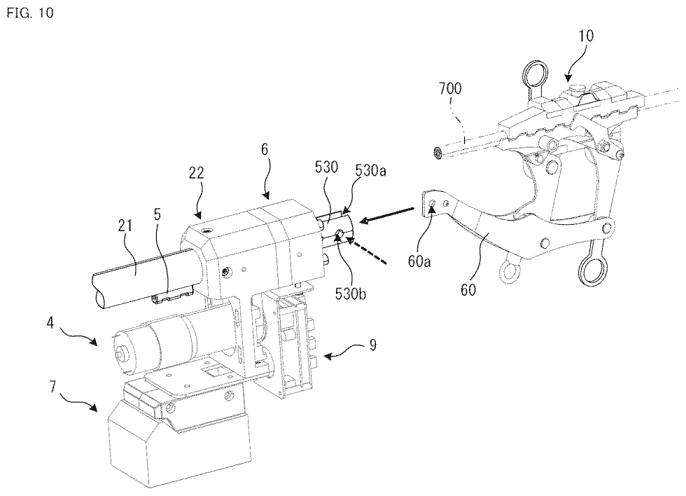

FIG. 10 is a perspective view showing a configuration of a fixing member in the expander of the fourth embodiment.

A fixing member 530 shown in FIG. 10 has a cylindrical shape and is joined to or integrally formed with the stress applying member 62.

The fixing member 530 includes a groove 530a formed along the axial direction and a through hole 530b formed penetrating along a direction substantially orthogonal to the axial direction. The operation arm 60 of the wire gripper 10 also includes a through hole 60a formed at its left end (one end) along a direction substantially orthogonal to the axial direction.

The left end of the operation arm 60 is inserted into the groove 530a of the fixing member 530, and the through hole 530b is aligned with the through hole 60a. Thereafter, a bolt (not shown) is inserted through the through hole 530b and the through hole 60a, and a nut (not shown) is screwed with the protruding end. This allows the wire gripper 10 to be coupled to the end of the expander 1.

The type of wire gripper 10 is also selected depending on the type of wire to be gripped. Then, the expander 1 including the fixing member 530 or the fixing member 520 having a shape (configuration) suitable for coupling is selected depending on the configuration (shape) of the operation arm 60 of the wire gripper 10 to be selected.

In the case where the tension detection portion 6 is omitted, the fixing member 530 (the same applies to the fixing member 520) is provided at the right end (another end) of the moving portion 22 in the axial direction.

As described above, according to the first, second and fourth embodiments, the expanding and contracting actions of the expander 1 are configured to be performed by the driving portion 4 having the motor 41. Thus, the expander 1 itself assists in the work that requires a large amount of force, improving operability.

In addition, whereas conventionally two workers on a bucket in the air are required to work, it becomes possible for a single worker to work on the bucket in the air, thus improving workability. In addition, the remaining worker can grasp the work status of the worker on the bucket from the ground and give accurate instructions, thus improving safety.

In particular, the sensors 5, 5a, 5b, and 5c are provided in the present disclosure, thus enabling the expansion and contraction of the expander 1 to be accurately performed. In addition, the tension detection portion 6 is provided, so that the coated electric wire 700 can be prevented from being pulled more than necessary, and breakage or the like of the coated electric wire 700 can be prevented.

Furthermore, data obtained during work from these detection portions can be transmitted to an external terminal (such as a tablet terminal, etc.) via the communication unit 91 of the control board 9 and can be stored there. Then, it is possible to check the work history and manage the need for repairs, etc. to the expander 1 based on the obtained data, which is also preferable from the viewpoint of improving safety.

The external terminal may be a foot switch, a voice recognition device, etc. In this case, even in the case of working alone, both hands can be freed when operating the expander 1.

In addition, even in the case where a plurality of coated electric wires (wire-like bodies) 700 are simultaneously worked on using the respective wire tensioning devices 100, the wire tensioning work and the like can be performed using a single external terminal.

In addition, in the present disclosure, any two or more of the configurations of the first to fourth embodiments may be combined.

In addition, the present disclosure may be provided in each of the following aspects.

(1) An expander adapted to be used to pull wire, comprising: an outer cylinder portion; an inner cylinder portion inserted into the outer cylinder portion from one end in an axial direction; a moving portion including a screw shaft inserted through the outer cylinder portion and the inner cylinder portion, and a nut fixed to another end of the inner cylinder portion in the axial direction and screwed with the screw shaft; a driving portion configured to move the nut along the screw shaft by rotating the screw shaft about its axis; and a position detection portion provided on an outer circumferential side of the outer cylinder portion and including at least a sensor that detects a position of the nut.

(2) The expander according to (1), wherein: the nut is made of a metal material, and the sensor is a magnetic sensor.

(3) The expander according to (1) or (2), further comprising: a tension detection portion configured to detect tension applied to the wire.

(4) The expander according to (3), further comprising: a fixing member coupled to a wire gripper that grips the wire, wherein the tension detection portion includes a pressure sensor and a stress applying member that is connected to the fixing member and applies stress to the pressure sensor.

(5) The expander according to any one of (1) to (4), further comprising: a power transmission mechanism coupled to the screw shaft, wherein the driving portion is configured to rotate the screw shaft about its axis via the power transmission mechanism.

(6) The expander according to any one of (1) to (5), further comprising: a power supply part configured to supply power to at least the position detection portion.

(7) The expander according to any one of (1) to (6), further comprising: a control board configured to control at least the position detection portion.

(8) The expander according to any one of (1) to (7), wherein: the driving portion further includes a motor that rotates the screw shaft about its axis.

(9) A wire tensioning device, comprising: an expander configured by the expander according to any one of (1) to (8); and a pair of wire grippers each coupled to both ends of the expander.

Of course, the present disclosure is not limited to the above aspects.

Finally, various embodiments of the present disclosure have been described, but these are presented as examples and are not intended to limit the scope of the invention. Novel embodiments can be implemented in various other forms, and various omissions, replacements, and modifications can be made within the scope of the spirit of the invention. The embodiments and its modifications are included in the scope and the spirit of the invention and are included in the scope of the invention described in claims and the equivalent scope thereof.

1. An expander adapted to be used to pull wire, comprising:
an outer cylinder portion;
an inner cylinder portion inserted into the outer cylinder portion from one end in an axial direction;
a moving portion including a screw shaft inserted through the outer cylinder portion and the inner cylinder portion, and a nut fixed to another end of the inner cylinder portion in the axial direction and screwed with the screw shaft;
a driving portion configured to move the nut along the screw shaft by rotating the screw shaft about its axis; and
a position detection portion provided on an outer circumferential side of the outer cylinder portion and including at least a sensor that detects a position of the nut.

2. The expander according to claim 1, wherein:
the nut is made of a metal material, and
the sensor is a magnetic sensor.

3. The expander according to claim 1, further comprising:
a tension detection portion configured to detect tension applied to the wire.

4. The expander according to claim 3, further comprising:
a fixing member coupled to a wire gripper that grips the wire, wherein
the tension detection portion includes a pressure sensor and a stress applying member that is connected to the fixing member and applies stress to the pressure sensor.

5. The expander according to claim 1, further comprising:
a power transmission mechanism coupled to the screw shaft, wherein
the driving portion is configured to rotate the screw shaft about its axis via the power transmission mechanism.

6. The expander according to claim 1, further comprising:
a power supply part configured to supply power to at least the position detection portion.

7. The expander according to claim 1, further comprising:
a control board configured to control at least the position detection portion.

8. The expander according to claim 1, wherein:
the driving portion further includes a motor that rotates the screw shaft about its axis.

9. A wire tensioning device, comprising:
an expander configured by the expander according to claim 1; and
a pair of wire grippers each coupled to both ends of the expander.
